(19) United States
(12) Patent Application Publication
(10) Pub. No.: US 2024/0262946 A1
(43) Pub. Date: Aug. 8, 2024

(54) ETHYLENE-A-OLEFIN COPOLYMER AND PROCESS FOR MANUFACTURING THEREOF

(71) Applicant: SABIC GLOBAL TECHNOLOGIES B.V., BERGEN OP ZOOM (NL)

(72) Inventors: Lidong Li, Riyadh (SA); Nasser Abdullah AlSaif, Riyadh (SA); Yahya Banat, Riyadh (SA); Mohammad Al-Shibel, Riyadh (SA)

(21) Appl. No.: 18/565,730

(22) PCT Filed: May 23, 2022
(86) PCT No.: PCT/EP22/63901

§ 371 Date: Nov. 30, 2023

(30) Foreign Application Priority Data
Jun. 16, 2021 (EP) 21179818.6

(51) Int. Cl. C08F 210/16

(52) U.S. Cl. CPC C08F 210/16

(57) ABSTRACT

An ethylene-α-olefin copolymer includes moieties derived from ethylene and moieties derived from an α-olefin comprising 3 to 10 carbon atoms, wherein the copolymer has: a short chain branching ratio (SCBR) of >1.40;
a short chain branching content of ≥15.0/1000 C; a molecular weight distribution M_{w}/Mₙ of ≥10.0; and a quantity of polymer moieties derived from an α-olefin comprising 3 to 10 carbon atoms of ≥1.0 and ≤20.0 wt %, with regard to the total weight of the copolymer. Such copolymer demonstrates improved melt processability, as well as allows for manufacturing of films having desirable mechanical properties, in particular in production of films such as by blown film production or by cast film production.

### CROSS REFERENCE TO RELATED APPLICATIONS

This application is a National Stage application of PCT/EP2022/063901, filed May 23, 2022, which claims the benefit of European Application No. 21179818.6, filed Jun. 16, 2021, both of which are incorporated by reference in their entirety herein.

### BACKGROUND

The present invention related to an ethylene-α-olefin copolymer and to a process for manufacturing thereof. In particular, the invention relates to an ethylene-α-olefin copolymer having a desirable balance of thermal processability in film manufacturing and mechanical properties of films obtained from such process.

Polymers produced from ethylene are well known to be of the most versatile polymeric materials available. Capable of being produced in an economic way at high and consistent product quality, and, by variation of amongst others polymerisation conditions and raw material formulations, in a wide array of grades each satisfying certain application needs, suitable for use in the production of a multitude of articles.

### SUMMARY

Ethylene-α-olefin copolymer includes moieties derived from ethylene and moieties derived from an α-olefin comprising 3 to 10 carbon atoms, wherein the copolymer has:
a short chain branching ratio (SCBR) of >1.40, preferably of >1.40 and <5.00, more preferably >1.60 and <5.00, even more preferably >1.80 and <4.00, even more preferably >2.00 and <3.00,
wherein SCBR is defined as:

$$SCBR = \frac{{SCB}_{500}}{{SCB}_{10}}$$

wherein SCB₅₀₀ is the quantity of short chain branches (SCB) of the copolymer at M_{w}=500,000 g/mol and SCB₁₀ is the quantity of short chain branches of the copolymer at M_{w}=10,000 g/mol, wherein the SCB quantity is determined via GPC-IR and expressed as the number of branches per 1000 carbon atoms (/1000 C);
a short chain branching content of ≥15.0/1000 C, preferably ≥15.0 and ≤35.0;
a molecular weight distribution M_{w}/Mₙ of ≥10.0, preferably ≥10.0 and ≤20.0, more preferably ≥11.0 and ≤20.0, even more preferably ≥12.0 and ≤20.0, even more preferably ≥13.0 and ≤20.0, wherein M_{w} is the weight average molecular weight, and Mₙ is the number average molecular weight, M_{w} and Mₙ being determined in accordance with ASTM D6474 (2012); and
a quantity of polymer moieties derived from an α-olefin comprising 3 to 10 carbon atoms of ≥1.0 and ≤20.0 wt %, with regard to the total weight of the copolymer.

### BRIEF DESCRIPTION TO THE DRAWINGS

A description of the figures, which are meant to be exemplary and not limiting, is provided in which:

FIG. 1 presents the distribution of the short-chain branches of the polymers of examples 1-5, as determined via the SCB analysis method disclosed herein;

FIG. 2 presents the A-TREF elution curve of the polymers of examples 1-5 as obtained according to the method described herein;

FIG. 3 presents the CEF curve of the polymers of examples 1-5 as obtained according to the method described herein; and

FIG. 4 presents a molecular weight distribution of examples 1-5 as obtained according to the method described herein.

### DETAILED DESCRIPTION

Polymers produced from ethylene, also referred to as polyethylenes, may in certain circumstances be produced using further monomers next to ethylene as part of the raw material formulation used in the polymerisation reactions. Typical further monomers, referred to as comonomers, may include α-olefins, particularly α-olefins having 3 to 10 carbon atoms. Such α-olefin comprising 3 to 10 carbon atoms may for example be selected from propylene, 1-butene, 1-pentene, 1-hexene, 1-octene, and 4-methyl-1-pentene. Particularly appropriate compounds to be used as comonomer are 1-butene, 1-hexene and 1-octene.

In the ethylene-α-olefin copolymer according to the invention, one single comonomer may be used, or a combination of multiple comonomers may be used. It is preferred that one single comonomer is used. Accordingly, it is preferred that the ethylene-α-olefin copolymer according to the invention comprises moieties derived from ethylene and moieties derived from a single comonomer.

A particular type of applications in which polyethylenes find abundant use is in films and laminates of films. There exist various techniques for manufacturing of films out of polyethylenes, including cast film production, blown film production, and oriented film production. In each of these techniques, the polyethylene materials are first brought to molten conditions, and subsequently the molten material is converted into a film-shape and solidified, typically by forcing the molten material through a die having such dimensions to allow the desired film to be obtained from the process, and subsequent cooling down to below melting point to solidify the film.

In order to adequately manufacture such film, and to ensure that the film complies with the required properties, stringent conditions are set for the nature of the polyethylene material. Current trends in applications of polyethylene films, such as a combination of increase in production speed, down-gauging of the films to reduce the quantity of materials used, and increased mechanical property demands, act as driver for the polymer industry to continue to develop polyethylene materials that meet these criteria. Much can be achieved by developing materials having certain design of molecular architecture, which is of significant effect to the final properties of the material.

In that respect, the present invention provides an ethylene-α-olefin copolymer comprising moieties derived from ethylene and moieties derived from an α-olefin comprising 3 to 10 carbon atoms, wherein the copolymer has:
a short chain branching ratio (SCBR) of >1.40, preferably of >1.40 and <5.00, wherein SCBR is defined as:

$$SCBR = \frac{{SCB}_{500}}{{SCB}_{10}}$$

wherein SCB₅₀₀ is the quantity of short chain branches (SCB) of the copolymer at M_{w}=500,000 g/mol and SCB₁₀ is the quantity of short chain branches of the copolymer at M_{w}=10,000 g/mol, wherein the SCB quantity is determined via GPC-IR and expressed as the number of branches per 1000 carbon atoms (/1000 C);
a short chain branching content of ≥15.0/1000 C, preferably ≥15.0 and ≤35.0;
a molecular weight distribution M_{w}/Mₙ of ≥10.0, preferably ≥10.0 and ≤20.0, wherein M_{w} is the weight average molecular weight, and Mₙ is the number average molecular weight, M_{w} and Mₙ being determined in accordance with ASTM D6474 (2012); and
a quantity of polymer moieties derived from an α-olefin comprising 3 to 10 carbon atoms of ≥1.0 and ≤20.0 wt %, with regard to the total weight of the copolymer.

Such copolymer demonstrates improved melt processability, as well as allows for manufacturing of films having desirable mechanical properties, in particular in production of films such as by blown film production or by cast film production.

The M_{w}/Mₙ of the ethylene-α-olefin copolymer may for example be ≥11.0 and ≤20.0, preferably ≥12.0 and ≤20.0, more preferably ≥13.0 and ≤20.0.

The SCBR of the ethylene-α-olefin copolymer may for example be >1.60, preferably >1.80, more preferably >2.00. The SCBR of the ethylene-α-olefin copolymer may for example be >1.60 and <5.00, preferably >1.80 and <4.00, more preferably >2.00 and <3.00.

The ethylene-α-olefin copolymer may for example have a molecular weight ratio M_{z}/M_{w} of ≥3.0, preferably ≥3.0 and ≤10.0, wherein M_{z} is the z-average molecular weight as determined in accordance with ASTM D6474 (2012).

In the ethylene-α-olefin copolymer according to the invention, the α-olefin may for example be selected from 1-butene, 1-hexene and 1-octene. It is preferred that the α-olefin is 1-butene or 1-hexene. The ethylene-α-olefin copolymer comprises ≥1.0 and ≤20.0 wt % of polymer moieties derived from an α-olefin comprising 3 to 10 carbon atoms, with regard to the total weight of the copolymer, preferably ≥1.0 and ≤15.0 wt %, more preferably ≥1.0 and ≤10.0 wt %, even more preferably ≥2.0 and ≤10.0 wt %, yet even more preferably ≥2.0 and ≤5.0 wt %. Preferably, the ethylene-α-olefin copolymer comprises ≥1.0 and ≤20.0 wt % of polymer moieties derived from an α-olefin selected from 1-butene, 1-hexene and 1-octene, with regard to the total weight of the copolymer, preferably ≥1.0 and ≤15.0 wt %, more preferably ≥1.0 and ≤10.0 wt %, even more preferably ≥2.0 and ≤10.0 wt %, yet even more preferably ≥2.0 and ≤5.0 wt %. More preferably, the ethylene-α-olefin copolymer comprises ≥1.0 and ≤20.0 wt % of polymer moieties derived from an α-olefin selected from 1-butene and 1-hexene, with regard to the total weight of the copolymer, preferably ≥1.0 and ≤15.0 wt %, more preferably ≥1.0 and ≤10.0 wt %, even more preferably ≥2.0 and ≤10.0 wt %, yet even more preferably ≥2.0 and ≤5.0 wt %. Even more preferably, the ethylene-α-olefin copolymer comprises ≥1.0 and ≤20.0 wt % of polymer moieties derived from 1-hexene, with regard to the total weight of the copolymer, preferably ≥1.0 and ≤15.0 wt %, more preferably ≥1.0 and ≤10.0 wt %, even more preferably ≥2.0 and ≤10.0 wt %, yet even more preferably ≥2.0 and ≤5.0 wt %.

In the context of the present invention, the quantity of polymer moieties derived from an α-olefin content may be determined using ¹³C Nuclear Magnetic Resonance on a Bruker Avance 500 spectrometer equipped with a cryogenically cooled probe head operating at 125° C., whereby the samples are dissolved at 130° C. in C₂D₂Cl₄ containing DBPC as stabiliser.

The ethylene-α-olefin copolymer according to the invention may for example have a density of ≥900 and ≤940 kg/m³, preferably of ≥910 and ≤925 kg/m³, wherein the density is determined in accordance with ASTM D1505-18.

The ethylene-α-olefin copolymer according to the invention may for example have a melt mass-flow rate at 2.16 kg and 190° C. of ≥0.1 and ≤25.0 g/10 min, preferably of ≥0.1 and ≤15.0 g/10 min, more preferably of ≥0.1 and ≤10.0 g/10 min, even more preferably of ≥0.1 and ≤5.0 g/10 min, yet even more preferably of ≥0.3 and ≤2.0 g/10 min, most preferably of ≥0.5 and ≤1.5 g/10 min.

The ethylene-α-olefin copolymer according to the invention may for example have a melt mass-flow rate at 21.6 kg and 190° C. of ≥25.0 g/10 min, preferably of ≥30.0 g/10 min, preferably of ≥30.0 and ≤100.0 g/10 min, more preferably of ≥30.0 and ≤75.0 g/10 min, even more preferably of ≥30.0 and ≤50.0 g/10 min.

The ethylene-α-olefin copolymer according to the invention may for example have a melt index ratio, calculated by dividing the melt mass-flow rate at 21.6 kg and 190° C. by the melt mass-flow rate at 2.16 kg and 190° C., of ≥25.0, preferably of ≥25.0 and ≤100.0, more preferably of ≥30.0 and ≤75.0, even more preferably of ≥30.0 and ≤50.0.

In the context of the present invention, the melt mass-flow rate is determined in accordance with ASTM D1238-20.

The ethylene-α-olefin copolymer according to the invention may for example show two distinct peaks in crystallisation elution fractionation (CEF), wherein a first peak is present in the elution temperature range of ≥65° C. and ≤80° C., and a second peak is present in the elution temperature range of ≥85° C. and ≤100° C.

The ethylene-α-olefin copolymer according to the invention may for example have an analytical temperature rising elution fractionation (a-TREF) profile such that in the elution temperature range of ≥30° C. and ≤94° C., ≥80.0 wt % is eluted, preferably ≥80.0 and ≤95.0 wt %, with regard to the total weight of eluted material.

The ethylene-α-olefin copolymer according to the invention may for example have an analytical temperature rising elution fractionation (a-TREF) profile such that in the elution temperature range of ≤30° C., ≤5.0 wt % is eluted, with regard to the total weight of eluted material.

The ethylene-α-olefin copolymer according to the invention may for example have an analytical temperature rising elution fractionation (a-TREF) profile such that in the elution temperature range of ≥94° C., ≤15.0 wt % is eluted, preferably ≤10.0 wt %, more preferably ≤5.0 wt %, with regard to the total weight of eluted material.

The ethylene-α-olefin copolymer according to the invention may for example show two or more, preferably two, peaks in the graph presenting eluted weight over elution temperature as determined via crystallisation elution fractionation (CEF). Particularly preferable is an embodiment of the invention wherein the ethylene-α-olefin copolymer has a ratio of CEF dW/dt at peak 2 over CEF dW/dt at peak 1 of ≤5.0, preferably of ≤3.0, more preferably of ≤2.0, wherein peak 1 is the peak occurring at lowest temperature in the CEF graph presenting eluted weight over elution temperature, and peak 2 is the peak following peak 1 in the direction of increased temperature, and wherein dW/dt at peak 1 is the eluted weight, in wt %, at the temperature of peak 1, and dW/dt at peak 2 is the eluted weight, in wt %, at the temperature of peak 2, both with regard to the total eluted weight. CEF in the context of the present invention may be determined in accordance with the method set out in the experimental section herein below.

In the context of the present invention, the SCB quantity is determined via infrared-detection gel permeation chromatography (GPC-IR). GPC-IR analysis may for example be performed using a chromatographer, such as a Polymer Char GPC-IR system, equipped with three columns of internal diameter 7.5 mm and 300 mm length, packed with of particles of 13 μm average particle size, such as Polymer Laboratories 13 μm PLgel Olexis, operating at 160° C., equipped with an MCT IR detector, wherein 1,2,4-trichlorobenzene stabilised with 1 g/l butylhydroxytoluene may be used as eluent at a flow rate of 1 ml/min, with a sample concentration of 0.7 mg/ml and an injection volume of 200 μl, with molar mass being determined based on the universal GPC principle using a calibration made with PE narrow and broad standards in the range of 0.5-2800 kg/mol, Mw/Mn—4 to 15 in combination with known Mark Houwink constants of PE-calibrant alfa=0.725 and log K=−3.721. Short chain branching content was determined via IR determination of the intensity ratio of CH₃ (I_{CH3}) to CH₂ (I_{CH2}) coupled with a calibration curve. The calibration curve is a plot of SCB content (X_{SCB}) as a function of the intensity ratio of I_{CH3}/I_{CH2}. To obtain a calibration curve, a group of polyethylene resins (no less than 5) (SCB Standards) were used. All these SCB Standards have known SCB levels and flat SCBD profiles. Using SCB calibration curves thus established, profiles of short chain branching distribution across the molecular weight distribution can be obtained for resins fractionated by the IR5-GPC system under exactly the same chromatographic conditions as for these SCB standards. A relationship between the intensity ratio and the elution volume is converted into SCB distribution as a function of MWD using a predetermined SCB calibration curve (i.e., intensity ratio of I_{CH3}/I_{CH2} VS. SCB content) and MW calibration curve (i.e., molecular weight vs. elution time) to convert the intensity ratio of I_{CH3}/I_{CH2} and the elution time into SCB content and the molecular weight, respectively.

Further, the invention also relates to a process for production of the ethylene-α-olefin copolymer.

In an embodiment, the invention relates the a process for production of the ethylene-α-olefin copolymer according to the invention, wherein the process involves the polymerisation of ethylene and a quantity of an α-olefin having 3 to 10 carbon atoms in the presence of a catalyst system comprising a compound according to formula I:

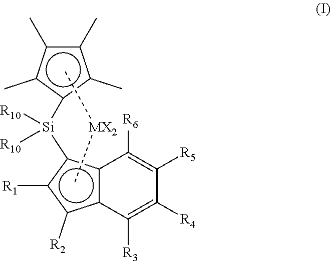

wherein R1 is selected from C2-C10 alkyl, preferably C3-C10 alkyl, C6-C20 aryl, C7-C20 aralkyl groups, wherein R2 is selected from H, C1-C10 alkyl, and wherein R3, R4, R5 and R6 are independently selected from H, C1-C10 alkyl, C6-C20 aryl, or C7-C20 aralkyl groups and wherein R3 and R4, R4 and R5, or R5 and R6 can be connected to form a ring structure, wherein each R10 is a hydrocarbyl group, preferably a C1-C4 alkyl group, wherein M is selected from Ti, Zr and Hf, preferably wherein M is zirconium or hafnium, most preferably M is zirconium; wherein X is an anionic ligand to M, preferably wherein X is a methyl group, Cl, Br or I, most preferably methyl or Cl; wherein R10 preferably is a C1-C4 alkyl group, most preferably a methyl group; wherein R1 preferably is selected from isopropyl, phenyl, and a 3,5-dialkyl-1-phenyl, preferably 3,5-dimethyl-1-phenyl, 3,5-diethyl-1-phenyl, 3,5-diisopropyl-1-phenyl or 3,5-di(t-butyl)-1-phenyl, most preferably wherein R1 is isopropyl; and wherein preferably each of R2-R6 are H.

In the process according the invention, the catalyst system may for example comprise the compound according to formula I immobilised on a support, wherein the support is a selected from talc, clay or inorganic oxides, preferably silica, alumina, magnesia, titania or zirconia. It is particularly preferable that the support is silica. For example, the support may be a silica having a surface area between 200 and 900 m²/g and/or a pore volume of >0.5 and <4.0 ml/g.

The catalyst system may for example also comprise a cocatalyst compound. Such cocatalyst is to function to generate a cationic specie from the compound and to form a so-called non-coordinating or weakly coordinating anion. Such cocatalysts may for example be selected from aluminium- or boron-containing cocatalysts. Such aluminium-containing cocatalysts may for example be selected from aluminoxanes, alkyl aluminium compounds, and aluminium-alkyl-chlorides. The aluminoxanes that may be used include for example oligomeric linear, cyclic and/or cage-like alkyl aluminoxanes. Suitable aluminium-containing cocatalysts may for example be selected from methylaluminoxane, trimethylaluminium, triethylaluminium, triisopropylaluminium, tri-n-propylaluminium, triisobutylaluminium, tri-n-butylaluminium, tri-t-butylaluminium, triamylaluminium, dimethylaluminium ethoxide, diethylaluminium ethoxide, diisopropylaluminium ethoxide, di-n-propylaluminium ethoxide, diisobutylaluminium ethoxide, di-n-butylaluminium ethoxide, dimethylaluminium hydride, diethylaluminium hydride, diisopropylaluminium hydride, di-n-propylaluminium hydride, diisobutylaluminium hydride, and di-n-butylaluminium hydride. Suitable boron-containing cocatalysts include for example triakylboranes, for example trimethylborane, triethylborane, and perfluoroarylborane compounds. For example, the cocatalyst may be methylaluminoxane.

For example, the cocatalyst may be selected from aluminium- or boron-containing cocatalysts, preferably from aluminoxanes, alkyl aluminium compounds, and aluminium-alkyl-chlorides.

The process according to the invention may for example be a gas-phase polymerisation process, a slurry polymerisation process, or a solution polymerisation process. In a particularly preferred embodiment, the process is a gas-phase polymerisation process operated in a polymerisation plant comprising at least one fluidised-bed reactor.

In certain embodiments, the invention also relates to an article comprising the ethylene-α-olefin copolymer according to the invention, preferably wherein the article is a film or a laminate. The invention also relates, in a certain embodiment, to the use of an ethylene-α-olefin copolymer according to the invention to improve the melt processability in production of films by blown film production or by cast film production.

The invention will now be illustrated by the following non-limiting examples.

### Supported Catalyst Preparation

### Supported Catalyst A

A 3 l. autoclave reactor equipped with a heating/cooling control unit and a mechanical stirring system was baked at 150° C. under a nitrogen flow for 2 hours and then cooled down to 30° C. 200 g of Grace Sylopol 955W silica, pre-dehydrated at 600° C. for 3 hrs, was charged to the reactor followed by addition of 480 ml of toluene. 2.44 g of metallocene compound Me₂Si(Me₄Cp)(1-(2-iPr-Ind))ZrCl₂ (CAS reg nr. 2247072-26-8) was activated by mixing it with 514 ml of a 10 wt % methyl aluminoxane (MAO) solution at 50° C. for 30 min. The activated metallocene was transferred into the autoclave reactor under stirring. An antistatic reagent modifier prepared by reacting 0.25 g of cyclohexylamine and 0.50 g of triisobutyl aluminium in 200 ml of toluene was added and the reaction mixture was stirred at 50° C. for 2 hours. After drying at 75° C. under vacuum of 135 mbar, the finished catalyst was isolated as light-yellow free-flowing powder. The catalyst contained 0.18 wt % of Zr and 8.5 wt % of Al, corresponding to a molar ratio Al/Zr of 160.

### Supported Catalyst B

A 3 l. autoclave reactor equipped with a heating/cooling control unit and a mechanical stirring system was baked at 150° C. under a nitrogen flow for 2 hours and then cooled down to 30° C. 200 g of Grace Sylopol 955W silica, pre-dehydrated at 600° C. for 3 hrs, was charged to the reactor followed by addition of 480 ml of toluene. 2.03 g of metallocene compound Me₂Si(Me₄Cp)(1-(2-iPr-Ind))ZrCl₂ (CAS reg nr. 2247072-26-8) was activated by mixing it with 513 ml of a 10 wt % methyl aluminoxane (MAO) solution at 50° C. for 30 min. The activated metallocene was transferred into the autoclave reactor under stirring. An antistatic reagent modifier prepared by reacting 0.25 g of cyclohexylamine and 0.50 g of triisobutyl aluminium in 200 ml of toluene was added and the reaction mixture was stirred at 50° C. for 2 hours. After drying at 75° C. under vacuum of 135 mbar, the finished catalyst was isolated as light-yellow free-flowing powder. The catalyst contained 0.15 wt % of Zr and 8.5 wt % of Al, corresponding to a molar ratio Al/Zr of 191.

### Comparative Catalyst C

At room temperature, 0.595 kg of 2,2′-bis(2-indenyl)biphenyl zirconium dichloride (CAS reg. nr. 312968-31-3) was added in a first vessel to 36.968 kg of a 30% methylaluminoxane solution (Al content 13.58 wt %) and stirred for 30 min. to form an activated single-site catalyst component. 172 kg of dry toluene was added to 43 kg of Grace Sylopol 955W silica, having an average surface area of 300 m²/g, an average pore volume of 1.65 g/cm³, and an average pore size of 220 Å. At a temperature of 30° C., the activated single-site catalyst component was added. The temperature was increased to 50° C. under stirring. The modifier was prepared by adding in a second vessel at room temperature 0.114 kg of triisobutylaluminium to a solution of 0.057 kg cyclohexylamine in 9.7 kg of dry toluene. After maintaining the contents of the first vessel at a temperature of 50° C. for 2 hours, the modifier was added to the first vessel. The temperature was lowered to 30° C., The toluene was removed by filtration and the obtained single-site catalyst system was dried by raising the temperature to 55° C. using a flow of nitrogen. A solid single-site catalyst system was obtained.

### Polymerisation

Polymerisation experiments were conducted in a continuous gas phase fluidised bed reactor having an internal diameter of 45 cm and a reaction zone height of 140 cm. the fluidised bed was made up of polymer granules. The reactor was filled with a bed of 40 kg of dry polymer particles that was vigorously agitated by a high-velocity gas stream. The bed of polymer particles in the reaction zone was kept in a fluidised state by a recycle stream that worked as fluidising medium as well as heat-dissipating agent for absorbing the exothermal heat generated in the reaction zone.

The individual flow rates of ethylene, hydrogen and comonomer were controlled to maintain fixed composition targets. The ethylene concentration was controlled to maintain a constant ethylene partial pressure. The hydrogen/ethylene flow ratio was well controlled to maintain a steady melt index of the final polymer that was produced. The concentrations of all of the gases were measured by an in-line gas chromatograph to ensure constant composition in the recycle gas stream. A continuity aid agent was mixed with the make-up stream as a 2 wt % solution in isopentane as carrier solvent, the continuity aid agent being fed at quantities of 0.06-0.12 kg/h.

The solid catalyst was injected directly into the reaction zone of the fluidised bed using purified nitrogen as carrier gas. The injection rate was adjusted to maintain a constant production rate. The produced polymer was discharged from the reaction zone semi-continuously via a series of valves into a fixed volume chamber. The obtained polymer was purged to remove any volatile hydrocarbons and was then treated with humidified nitrogen to deactivate any trace quantities of residual catalyst. The polymer product was thus obtained.

Process conditions as used in the examples are presented in table 1.

TABLE 1

| | Ex. 1 | Ex. 2 | Ex. 3 | Ex. 4 | Ex. 5 |
|---|---|---|---|---|---|
| Catalyst | A | A | B | B | C |
| T_{react} (° C.) | 84 | 84 | 87 | 87 | 87 |
| P_{react} (bar) | 20.6 | 20.6 | 20.7 | 20.7 | 20.7 |
| Superficial gas velocity (m/s) | 0.40 | 0.40 | 0.40 | 0.40 | 0.40 |
| Recycle gas composition (mole fraction) | | | | | |
| Ethylene (C2) (%) | 47.8 | 46.5 | 53.4 | 55.6 | 44.5 |
| 1-Hexene (C6) (%) | 1.3 | 1.5 | 1.7 | 1.7 | 6.1 |
| Hydrogen (H2) (%) | 0.05 | 0.05 | 0.08 | 0.12 | 0.0068 |
| Nitrogen (%) | 50.7 | 51.8 | 44.7 | 42.5 | 49.4 |
| C6/C2 molar ratio | 0.028 | 0.032 | 0.031 | 0.031 | 0.13 |
| H2/C2 molar ratio | 0.0011 | 0.0011 | 0.0015 | 0.0022 | 0.00015 |

Material properties of the polymers produced in each of the examples are presented in table 2.

TABLE 2

| | Ex. 1 | Ex. 2 | Ex. 3 | Ex. 4 | Ex. 5 |
|---|---|---|---|---|---|
| Melt mass-flow rate MFR2 (g/10 min) | 1.10 | 1.13 | 0.95 | 1.10 | 1.24 |
| MFR21 (g/10 min) | 42.26 | 42.94 | 32.08 | 43.85 | 23.99 |
| MIR (MFR2/MFR21) | 38.42 | 38.00 | 33.77 | 39.86 | 19.35 |
| Density (kg/m³) | 919.6 | 920.5 | 918.0 | 917.9 | 921.2 |
| Bulk density (kg/m³) | 340 | 339 | 374 | 389 | 385 |
| Ash content (ppm) | 460 | 520 | 430 | 450 | 228 |
| Average particle size (mm) | 0.489 | 0.480 | 0.454 | 0.470 | 0.594 |
| Fines (%) | 0.20 | 0.20 | 0.30 | 0.20 | 0.40 |
| Mₙ (kg/mol) | 8 | 8 | 9 | 7 | 32 |
| M_{w} (kg/mol) | 135 | 110 | 110 | 110 | 124 |
| M_{z} (kg/mol) | 1000 | 770 | 370 | 640 | 297 |
| M_{w}/Mₙ | 15.8 | 14.3 | 12.6 | 16.3 | 3.8 |
| M_{z}/M_{w} | 7.8 | 7.0 | 3.2 | 5.5 | 2.4 |
| SCB (/1000 C) | 16.2 | 17.2 | 17.4 | 17.8 | 14.5 |
| SCB @10K (/1000 C) | 12.17 | 9.43 | 14.48 | 13.11 | 13.63 |
| SCB @100K (/1000 C) | 16.08 | 15.99 | 17.32 | 17.79 | 14.89 |
| SCB @500K (/1000 C) | 22.53 | 22.61 | 21.09 | 22.02 | 16.85 |
| SCB ratio | 1.85 | 2.40 | 1.46 | 1.68 | 1.24 |
| C6 (mol %) | 3.5 | 3.7 | 3.7 | 3.8 | 3.1 |
| T_{c} (° C.) | 104.1 | 102.5 | 101.2 | 102.7 | 109.7 |
| Tₘ (° C.) | 117.8 | 118.1 | 115.5 | 116.7 | 124.2 |
| Crystallinity (wt %) | 39.4 | 41.2 | 35.7 | 27.6 | 46.8 |
| a-TREF <30 (wt %) | 4.2 | 4.5 | 4.7 | 1.5 | 7.2 |
| a-TREF 30-94 (wt %) | 89.0 | 86.8 | 94.8 | 93.7 | 65.0 |
| a-TREF >94 (wt %) | 6.8 | 8.7 | 0.5 | 4.8 | 27.8 |
| CEF Tₘₐₓ of peak 1 (° C.) | 75.4 | 75.0 | 74.2 | 73.1 | 76.5 |
| CEF dW/dt at peak 1 (wt %) | 2.20 | 2.31 | 2.97 | 2.78 | 1.03 |
| CEF Tₘₐₓ of peak 2 (° C.) | 94.7 | 94.3 | 93.2 | 93.2 | 99.4 |
| CEF dW/dT at peak 2 (wt %) | 4.72 | 4.07 | 3.38 | 3.48 | 9.31 |

### Wherein:

the melt mass-flow rate was determined at a load of 2.16 kg (MFR2) and 21.6 kg (MFR21), at a temperature of 190° C., in accordance with ASTM D1238-20;
the density was determined in accordance with ASTM D1505-18;
the bulk density was determined in accordance with ASTM D1895-17;
the ash content was determined in accordance with ASTM D5630-13;
the average particle size was determined by measuring the weight fraction of particles collected on a series of U.S. Standard sieves;
the quantity of fines was determined as the wt % of particles that passed through a 120 mesh standard sieve;
the weight-average molecular weight (M_{w}), the number-average molecular weight (Mₙ) and the z-average molecular weight (M_{z}) were determined in accordance with ASTM D6474 (2012);
the SCB was determined via GPC-IR; SCB@10K is the SCB at M_{w}=10,000 g/mol; SCB@100K is the SBC at M_{w}=100,000 g/mol; SCB@500K is the SBC at M_{w}=500,000 g/mol; SCB ratio=SCB@500K/SCB@10K;
the C6 content was determined using ¹³C Nuclear Magnetic Resonance on a Bruker Avance 500 spectrometer equipped with a cryogenically cooled probe head operating at 125° C., whereby the samples were dissolved at 130° C. in C₂D₂Cl₄ containing DBPC as stabiliser;
the crystallisation temperature (T_{c}), the melting temperature (Tₘ) and the crystallinity were determined in accordance with ASTM D3418-08, recording two thermal cycles, using the second cycle data.
a-TREF <30 indicates the fraction of the polymer that is eluted in a-TREF according to the method presented below in the temperature range ≤30.0° C., expressed in wt %, and represents the amorphous fraction of the polymer, calculated by subtracting the a-TREF 30-94 and the a-TREF >94 fraction from 100.0 wt %;
a-TREF 30-94 indicates the fraction of the polymer that is eluted in a-TREF in the temperature range of >30.0 and ≤94.0° C., expressed in wt %, and represents the branched fraction of the polymer;
a-TREF >94 indicates the fraction of the polymer that is eluted in a-TREF in the temperature range of >94.0 and <140° C., expressed in wt %, and represents the linear fraction of the polymer;
CEF Tₘₐₓ of peak 1 is the peak temperature of the first peak as detected according to the CEF method as defined below (° C.);
CEF Tₘₐₓ of peak 2 is the peak temperature of the second peak as detected according to the CEF method as defined below (° C.);
CEF dW/dt at peak 1 is the weight fraction eluted at the first peak as detected according to the CEF method as defined below (wt %); and
CEF dW/dt at peak 2 is the weight fraction eluted at the second peak as detected according to the CEF method as defined below (wt %).

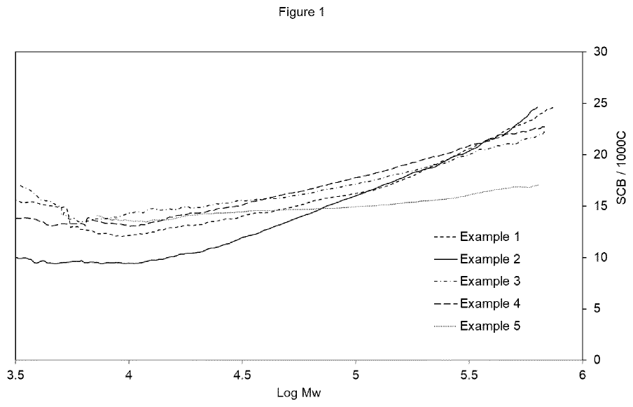

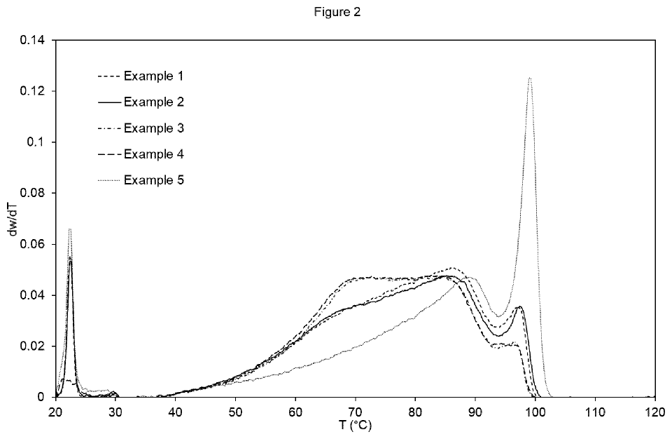

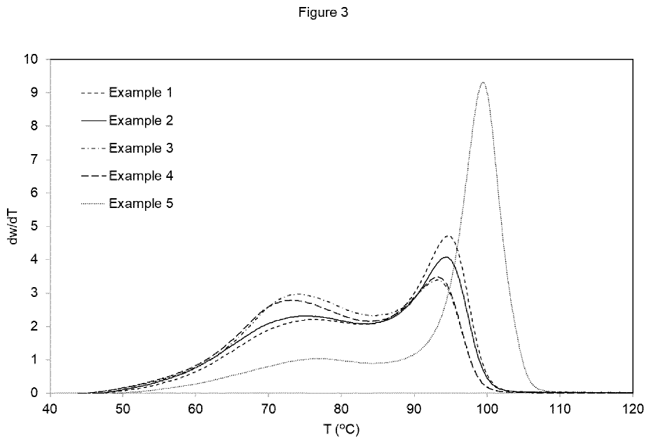

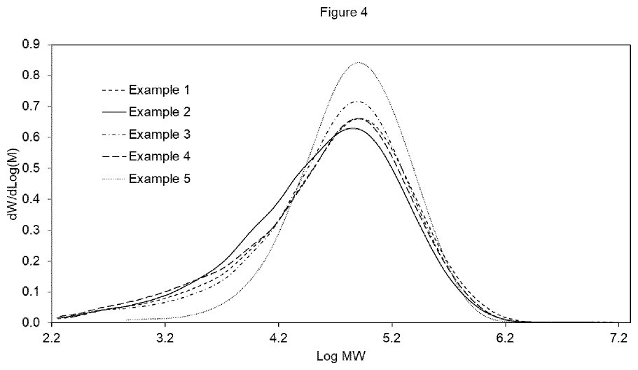

Description of figures: FIG. 1 presents the distribution of the short-chain branches of the polymers of examples 1-5, as determined via the SCB analysis method disclosed above. It can be observed that the polymers of examples 1-4 according to the invention have a higher SCB incorporation quantity at higher molecular weights than the comparative example 5, which is also reflected by a higher SCB ratio. The polymers of examples 1-4 thereby demonstrate improved melt processability and mechanical properties, in particular in production of films such as by blown film production or by cast film production. FIG. 2 presents the A-TREF elution curve of the polymers of examples 1-5 as obtained according to the method below. FIG. 3 presents the CEF curve of the polymers of examples 1-5 as obtained according to the method above. FIG. 4 presents a molecular weight distribution of examples 1-5 as obtained according to the method below.

The molecular weight distributions of the polymers were determined by gel permeation chromatography (GPC) recorded on an Agilent PL-GPC 220 chromatograph at 150° C. using 1,2,4-trichlorobenzene as diluent, equipped with a PL BV-400 viscosimeter and infrared detectors to collect the signal for molecular weights.

For each of the polymers as produced in the experiments above, analytical temperature rising elution fractionation (a-TREF) was conducted. A Polymer Char Crystaf-TREF 300 device was used. The composition to be analysed was dissolved in 1,2-dichlorobenzene of analytical quality, filtered via a 0.2 μm filter and allowed to crystallise in a column containing an inert support (column filled with 150 μm stainless steel beads, volume 2500 μl) by slowly reducing the temperature to 20° C. at a cooling rate of 0.1° C./min. The column was equipped with an infrared detector. An a-TREF chromatogram curve was then generated by eluting the crystallised polymer sample from the column by slowly increasing the temperature of the eluting solvent (1,2-dichlorobenzene) from 20° C. to 130° C. at a rate of 1° C./min. The solvent was stabilised using Topanol (1 g/l) and Irgafos 168 (1 g/l).

The results of the a-TREF fractionation are presented in FIG. 2. It can be observed that for the example 1-4, the major fraction elutes in the temperature range of 30-94° C., whereas the polymer that was obtained in example 5, included for comparative purposes, shows a significantly higher fraction eluted in the temperature range of >94° C., which is indicative of having a high crystallinity. The large fraction eluted in the 30-94° C. range in examples 1-4 indicates a more homogeneous comonomer distribution compared to example 5.

Crystallisation elution fractionation (CEF) analysis was conducted using a Polymer Char CEF instrument according to the method of Monrabal, B.; Mayo, N.; Romero, L.; Sancho-Tello, J.; Crystallization Elution Fractionation: A New Approach to Measure the Chemical Composition Distribution of Polyolefins, LCGC Europe (2011) and Monrabal, B.; del Hierro, P.; Characterization of polypropylene-polyethylene blends by temperature rising elution and crystallization analysis fractionation, Anal. Bioanal. Chem., 399, 1557-1561 (2011). The samples were first dissolved in 1,2,4 trichlorobenzene (TCB) in 1 mg/ml at 160° C. for 1 hour. TCB was stabilized by 1000 to 2000 ppm of BHT. At the end of the dissolution period, the samples were transferred from the autosampler to the injection loop using a dispenser. The content of the loop (0.2 to 0.3 ml) was injected into the CEF column using an isocratic pump. In the column, the polymers were fractionated using two temperature cycles. During the crystallization cycle, the column temperature was decreased to 35° C., at a typical cooling rate being from 1 to 5° C./min, under continuous TCB flow within the limits of the column. This solvent flow rate is calculated from the column volume, cooling rate, and the difference between the first and the last temperatures in the cooling cycle, typically 0.01 to 0.1 ml/min. At the end of the cooling cycle, the temperature was kept constant for few minutes and the solvent flow rate is increased to the elution flow rate value, typically at 1 ml/min, to allow the soluble polymer to leave the column and reach the detector. The deposited fractions were then dissolved as the temperature increases from 35 to 160° C. at a rate of 1 to 4° C./min during the elution cycle using a continuous TCB flow that allows the fractions to move from the column to the detector in order to measure their concentrations. The infrared detector is located at the instrument's top oven and is kept at constant temperature. At the end of elution cycle, the column was cleaned with fresh solvent in order to be ready for the injection of the next sample.

The results were presented in FIG. 3, and showed a picture that is comparable to the a-TREF results. For the polymers obtained from examples 1 to 4, the major fraction locates at low crystallization temperature range from 46 to 102° C., whereas for the polymer obtained in comparative example 5, the major fraction lies at high crystallization temperature range from 88 to 109° C., indicating that the polymers obtained from examples 1 to 4 have more homogeneous comonomer distribution compared to that obtained in comparative example 5.

Of the polymers of example 2, 3 and comparative example 5, films were produced to determine the film properties. The polymers were processed on a Polyrema 3 layers blown film equipment. Each of three extruders was operated at a screw speed of 20 rpm. The polymer powders were melt-mixed with suitable additives in the screw extruder to produce the pellets. Films of 50 μm thickness were produced from the pellets on the blown film line, having a frost line height of 30 cm using a blow up ratio of 2.5 and a die output 55 kg/h. The line was equipped with a 200 mm die, a die gap of 2.5 mm, reversing haul-off, chilled cooling air, thickness profile measurement and back to back winder. The overall throughput was kept constant. Barrel temperature profiles were ramped from 185° C. at the feed section to 220° C. at the die. The implemented extrusion melt pressure for example 2 and example 3 (160 bar) was lower than that for example 5 (170 bar), indicating the better processability of samples from example 2 and example 3.

The below properties were determined on the films prepared as described above.

| | Example 2 | Example 3 | Example 5 |
|---|---|---|---|
| Melt mass-flow rate at 190° C., 2.16 kg (ASTM | 1.13 | 0.95 | 1.24 |
| D1238, 2013) in g/10 min | | | |
| Density (ASTM D792, 2008) in kg/m³ | 920.5 | 918.0 | 921.2 |
| Tensile strength at yield in machine direction | 8.5 | 7.9 | 7.8 |
| (MD) (ASTM D882, 2010), in MPa | | | |
| Tensile strength at yield in transverse direction | 8.1 | 7.3 | 7.3 |
| (TD) (ASTM D882, 2010), in MPa | | | |
| Tensile strength at break (MD) (ASTM D882, | 43.7 | 46.3 | 47.9 |
| 2010) in MPa | | | |
| Tensile strength at break (TD) (ASTM D882, | 44.4 | 44.0 | 38.8 |
| 2010) in MPa | | | |
| Elongation at break (MD) (ASTM D882, 2010) in | 940 | 892 | 1060 |
| % | | | |
| Elongation at break (TD) (ASTM D882, 2010) in | 994 | 962 | 1028 |
| % | | | |
| Secant modulus at 1% strain (MD) (ASTM D882, | 192.4 | 170 | 172.8 |
| 2010) in MPa | | | |
| Secant modulus at 1% strain (TD) (ASTM D882, | 224.8 | 200.2 | 188 |
| 2010) in MPa | | | |
| Dart drop impact (ASTM D1709, 2009) in g | >860 | >860 | 592.9 |
| Elmendorf tear strength (MD) (ASTM D1922, | 9.2 | 8.6 | 14.1 |
| 2015) in g/μm | | | |
| Elmendorf tear strength (TD) (ASTM D1922, | 19.3 | 17.6 | 17.8 |
| 2015) in g/μm | | | |
| Puncture resistance (ASTM D5748-95, 2012) in J | 4.87 | 2.96 | 4.22 |
| Clarity (ASTM D1003, 2000, procedure B) in % | 96.3 | 95.6 | 96.5 |
| Haze (ASTM D1003, 2000) in % | 14.3 | 11.5 | 14.8 |
| Gloss at 45° (ASTM D2457, 2013) in % | 52.3 | 49.5 | 47.7 |

1. An ethylene-α-olefin copolymer comprising moieties derived from ethylene and moieties derived from an α-olefin comprising 3 to 10 carbon atoms, wherein the copolymer has:
a short chain branching ratio (SCBR) of >1.40,
wherein SCBR is defined as:
$$SCBR = \frac{{SCB}_{500}}{{SCB}_{10}}$$
wherein SCB₅₀₀ is the quantity of short chain branches (SCB) of the copolymer at M_{w}=500,000 g/mol and SCB₁₀ is the quantity of short chain branches of the copolymer at M_{w}=10,000 g/mol, wherein the SCB quantity is determined via GPC-IR and expressed as the number of branches per 1000 carbon atoms (/1000 C);
a short chain branching content of ≥15.0/1000 C;
a molecular weight distribution M_{w}/Mₙ of ≥10.0, wherein M_{w} is the weight average molecular weight, and Mₙ is the number average molecular weight, M_{w} and Mₙ being determined in accordance with ASTM D6474 (2012); and
a quantity of polymer moieties derived from an α-olefin comprising 3 to 10 carbon atoms of ≥1.0 and ≤20.0 wt %, with regard to the total weight of the copolymer.

2. The ethylene-α-olefin copolymer according to claim 1, wherein the copolymer has a molecular weight ratio M_{z}/M_{w} of ≥3.0, wherein M_{z} is the z-average molecular weight as determined in accordance with ASTM D6474 (2012).

3. The ethylene-α-olefin copolymer according to claim 1, wherein the α-olefin is selected from 1-butene, 1-hexene and 1-octene.

4. The ethylene-α-olefin copolymer according to claim 1, wherein the copolymer has a density of ≥900 and ≤940 kg/m³, wherein the density is determined in accordance with ASTM D1505-18.

5. The ethylene-α-olefin copolymer according to claim 1, wherein the copolymer has a melt mass-flow rate at 2.16 kg and 190° C. of ≥0.1 and ≤25.0 g/10 min, wherein the melt mass-flow rate is determined in accordance with ASTM D1238-20.

6. The ethylene-α-olefin copolymer according to claim 1, wherein the copolymer has a melt mass-flow rate at 21.0 kg and 190° C. of ≥30.0 g/10 min, wherein the melt mass-flow rate is determined in accordance with ASTM D1238-20.

7. The ethylene-α-olefin copolymer according to claim 1, wherein the copolymer shows two distinct peaks in crystallisation elution fractionation (CEF), wherein a first peak is present in the elution temperature range of ≥65° C. and ≤80° C., and a second peak is present in the elution temperature range of ≥85° C. and ≤100° C.

8. The ethylene-α-olefin copolymer according to claim 1, wherein the copolymer has an analytical temperature rising elution fractionation (a-TREF) profile such that in the elution temperature range of ≥30° C. and ≤94° C., ≥80.0 wt % is eluted, with regard to the total weight of eluted material.

9. An article comprising the ethylene-α-olefin copolymer according to claim 1.

10. A process for production of an ethylene-α-olefin copolymer according to claim 1, wherein the process comprises polymerizing ethylene and a quantity of an α-olefin having 3 to 10 carbon atoms in the presence of a catalyst system comprising a compound according to formula I: 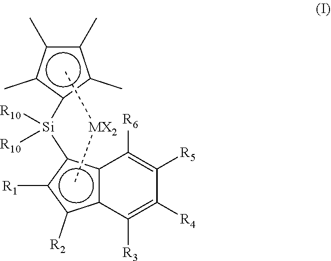
wherein R₁ is selected from C2-C10 alkyl, C6-C20 aryl, C7-C20 aralkyl groups, wherein R₂ is selected from H, C1-C10 alkyl, and wherein R₃, R₄, R₅ and R₆ are independently selected from H, C1-C10 alkyl, C6-C20 aryl, or C7-C20 aralkyl groups and wherein R₃ and R₄, R₄ and R₅, or R₅ and R₆ can be connected to form a ring structure, wherein each R₁₀ is a hydrocarbyl group,
wherein M is selected from Ti, Zr and Hf; wherein X is an anionic ligand to M.

11. The process according to claim 10, wherein the catalyst system comprises the compound according to formula I immobilised on a support, wherein the support is a selected from talc, clay or inorganic oxides.

12. The process according to claim 10, wherein the catalyst system comprises a cocatalyst compound selected from aluminium- or boron-containing cocatalysts.

13. The process according to claim 10, wherein the process is a gas-phase polymerisation process, a slurry polymerisation process, or a solution polymerisation process.

14. The process according to claim 13, wherein the process is a gas-phase polymerisation process operated in a polymerisation plant comprising at least one fluidised-bed reactor.

15. (canceled)

16. The article of claim 9, wherein the article is a film or a laminate.
